(19) United States
(12) Patent Application Publication
(10) Pub. No.: US 2007/0284900 A1
(43) Pub. Date: Dec. 13, 2007

(54) Foldable wagon

(75) Inventor: Wally Sze, Jardine's Lookout (HK)

Correspondence Address: ST. ONGE STEWARD JOHNSTON & REENS, LLC, 986 BEDFORD STREET, STAMFORD, CT, 06905-5619, US

(73) Assignee: Grow'n Up Limited, Hong Kong

(21) Appl. No.: 11/451,077

(22) Filed: Jun. 12, 2006

(51) Int. Cl. B60P 3/34

(52) U.S. Cl. 296/26.15

(57) ABSTRACT

The invention relates to a foldable wagon having a base and side panels around the base to define an open top enclosure. The side panels being a left side panel, a right side panel, a front panel, and a back panel all placed on the base and all are approximately perpendicular to the base. The front panel is hingedly attached to the left side panel while the back panel is hingedly attached to the right side panel. A safety lock is located at a junction between two adjacent panels for securing the adjacent panels together. A locking bar is attached to the base for securing the wagon in a folded or unfolded position, wherein the foldable wagon folds and unfolds without a fastener and wherein the foldable wagon folds and unfolds without removing or adding any of the panels.

### FIELD OF THE INVENTION

The invention relates to a foldable wagon.

### BACKGROUND OF THE INVENTION

Traditional wagons or other wheeled transport vehicles, such as trailers, generally transport objects from one location to another and are usually used to loads that may be heavy, large, or bulky. A wagon or wheeled transport vehicle normally has a flat bed, sidewalls or panels to help maintain the load on the flat bed, and wheels.

When not in use for transporting objects, wagons or other wheeled transport vehicles are generally difficult to stow away since most wagons or wheeled transport vehicles are bulky and take up room.

A possible solution to the above-noted problem is a foldable wagon. U.S. Pat. No. 1,820,466 to Lieblein relates to a foldable wagon but does not appear to have a locking mechanism that secures the wagon in both the folded and unfolded positions. Without a locking mechanism, the wagon may be accidentally unfolded and present a walking hazard. Moreover, it seems fasteners are needed to fasten the side panels in the unfolded position and that they need to be removed in order to commence folding. Such removal and reattachment of fasteners may be cumbersome and in the event they are lost or misplaced, the use of the foldable feature may be compromised.

U.S. Pat. No. 2,558,909 to Partiot is directed to a foldable wagon but does not seem to have side panels on the two sides of the wagon that fold because side panels may prevent the wagon from folding. Without side panels, objects may fall out of the wagon. Moreover, there does not appear to be a locking mechanism that secures the wagon in both the folded and unfolded positions.

U.S. Pat. No. 2,563,995 to East relates to a foldable wagon but also seems to require the side panels be separated from the base and wheels before being folded. Moreover, the side panels do not seem to be fastened to the base in a secure manner, which may result in accidental separation of the side panels from the base. If the side panels are indeed secured to the base, it seems fasteners are needed and, in the folded state, the fasteners are removed which could lead to them being misplaced.

U.S. Pat. No. 4,878,682 to Lee relates to a wagon that folds along its length but does not seem to have any locking devices for securing the wagon in the folded or unfolded state. Also, the wagon does not seem to have any side panels because the panels may prevent the wagon from folding.

U.S. Pat. No. 5,340,134 to Dodson relates to a wagon that folds but also seems to require that the side panels and wheels be removed in order for the wagon to be folded.

U.S. Pat. No. 6,536,796 to Solomon relates to a telescoping wagon with extendable side panels but does not appear to relate to a foldable wagon.

U.S. Pat. Nos. 5,857,695 and 4,887,836 to Crowell and Simjian relate to a wagon with foldable side panels. However, these references do not seem to relate to a wagon that folds for adjusting the width or length wherein the floor space taken up by the wagon is reduced.

What is desired, therefore, is a foldable wagon that takes up less floor space when in the folded position and has side panels on all sides of the wagon that do not need to be removed in order for the wagon to transform to the folded position. Another desire is a foldable wagon with a safety mechanism for securing the wagon in either the folded or unfolded position. A further desire is a foldable wagon that does not require the use of fasteners that must be removed and reattached because these fasteners may become lost or misplaced.

### SUMMARY OF THE INVENTION

It is therefore an object of the invention to provide a foldable wagon that may be stowed away in a manner that reduces floor space.

It is another object to provide a wagon that folds and unfolds without attaching or removing side panels or fasteners.

A further object is a wagon is securely held in a folded position or unfolded position.

Yet another object is a wagon that folds and unfolds easily and quickly.

These and other objects of the invention are achieved by a foldable wagon having a base and side panels around the base to define an open top enclosure. The side panels being a left side panel, a right side panel, a front panel, and a back panel all placed on the base and all are approximately perpendicular to the base. The front panel is hingedly attached to the left side panel while the back panel is hingedly attached to the right side panel. A safety lock is located at a junction between two adjacent panels for securing the adjacent panels together. A locking bar is attached to the base for securing the wagon in a folded or unfolded position, wherein the foldable wagon folds and unfolds without a fastener and wherein the foldable wagon folds and unfolds without removing or adding any of the panels.

In some embodiments, the locking bar is pivotably attachable to the base in a first location for securing the base in a folded position and in a second location for securing the base in an unfolded position.

In some embodiments, the safety lock is a front lock located at a junction between the front panel and the right side panel for securing the front panel to the right side panel, wherein the safety lock helps maintain the base in an unfolded position and, when removed, the front panel is free to be folded against the right side panel.

In other embodiments, the safety lock is a rear lock located at a junction between the rear panel and the left side panel for securing the rear panel to the left side panel, wherein the safety lock helps maintain the base in an unfolded position and, when removed, the front panel is free to be folded against the right side panel.

In further embodiments, the front panel and right side panel each have an extension with a hole, where both holes align with one another in an axial direction. The front lock includes a rod that extends through both holes to lock the extensions and therefore the front panel and right side panel together.

The foldable wagon may have a base with a left length, a middle length, and a right length. In some of these embodiments, a first hinge is placed between the left side panel and the left length; a second hinge is placed between the left length and the middle length; a third hinge placed between the middle length and the right length; and a fourth hinge placed between the right length and the right side panel.

The foldable wagon also includes at least one wheel attached to the base.

In another aspect of the invention, the front panel further includes a protrusion and the base includes a recess, wherein the protrusion is placed within the recess for securing the front panel to the base. In further embodiments, the base has a first recess for securing the front panel to the base in an unfolded position and the base has a second recess for securing the front panel to the base in a folded position.

Conversely, in other embodiments, the front panel further includes a recess and the base includes a protrusion, wherein the protrusion is placed within the recess for securing the front panel to the base.

Optionally, the foldable wagon includes a container attached to the locking bar for holding items. In other optional embodiments, a cup holder is pivotably attached to the left side panel or the right side panel and a toy holder is pivotably attached to the back panel or front panel.

### BRIEF DESCRIPTION OF THE DRAWINGS

FIG. 1 depicts the foldable wagon in accordance with the invention.

FIG. 2 depicts an underside of the foldable wagon shown in FIG. 1.

FIG. 3 depicts the safety locks of the foldable wagon shown in FIG. 1.

FIGS. 4a-4b depict a folding process of the front and back panels of the foldable wagon shown in FIG. 1.

FIGS. 5a-5c depict a folding process of the base of the foldable wagon shown in FIG. 1.

FIG. 6 depicts a locking bar securing the foldable wagon shown in FIG. 1 in a folded position.

FIG. 7 depicts a container attached to the foldable wagon shown in FIG. 1.

FIG. 8 depicts a toy holder attached to the foldable wagon shown in FIG. 1.

### DETAILED DESCRIPTION

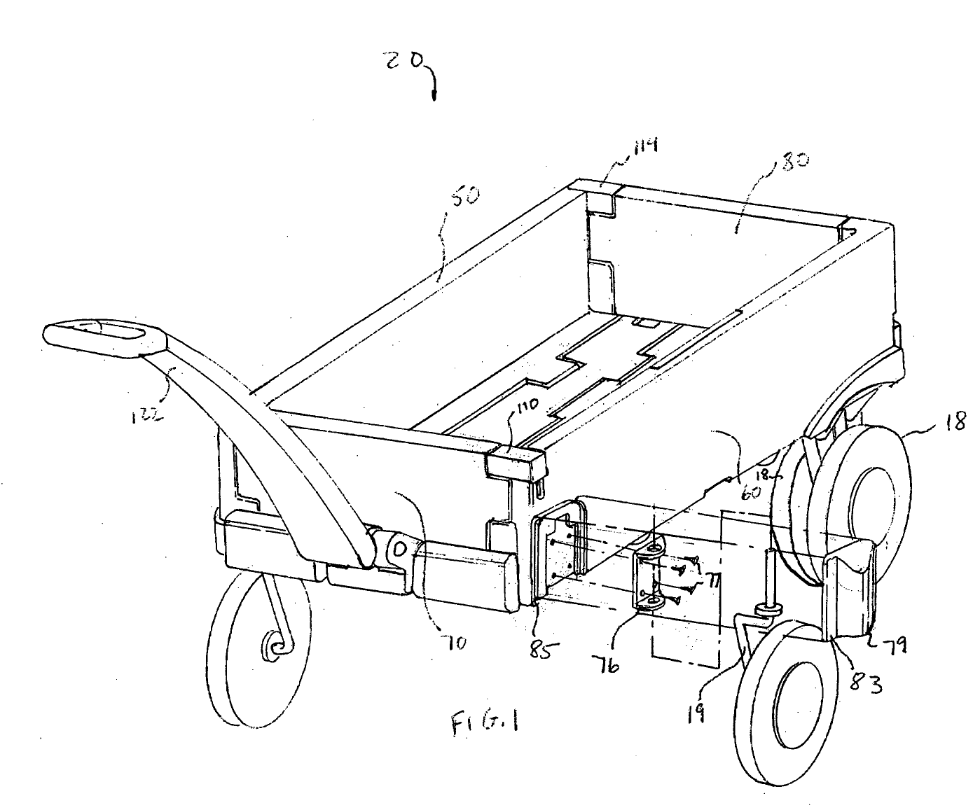

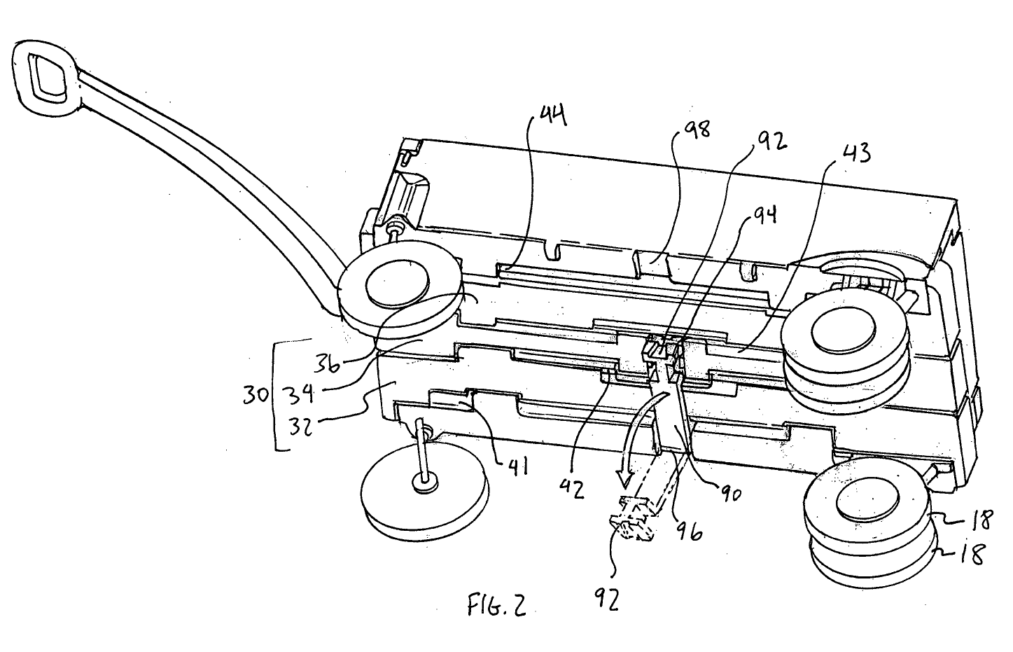

FIGS. 1 and 2 depict foldable wagon 20 in accordance with the invention. Wagon 20 includes base 30 having left length 32, middle length 34, and right length 36. Wagon 20 also includes left side panel 50, right side panel 60, front panel 70, and back panel 80, all of which are placed on top of base 30 and are all approximately perpendicular to said base 30 and together with base 30 define a compartment into which objects may be carried.

As shown, front panel 70 is hingedly attached to left side panel 50 and back panel 80 is hingedly attached to right side panel 60. Hinge 78 is any known or novel hinge for permitting rotation of a panel about the axis defined by front panel 70 and left side panel 50 or back panel 80 and right side panel 60, including a butt hinge, butterfly hinge, flush hinge, barrel hinge, concealed hinge, continuous or piano hinge, door hinge, cabinet hinge, hinge with bearings, and the like.

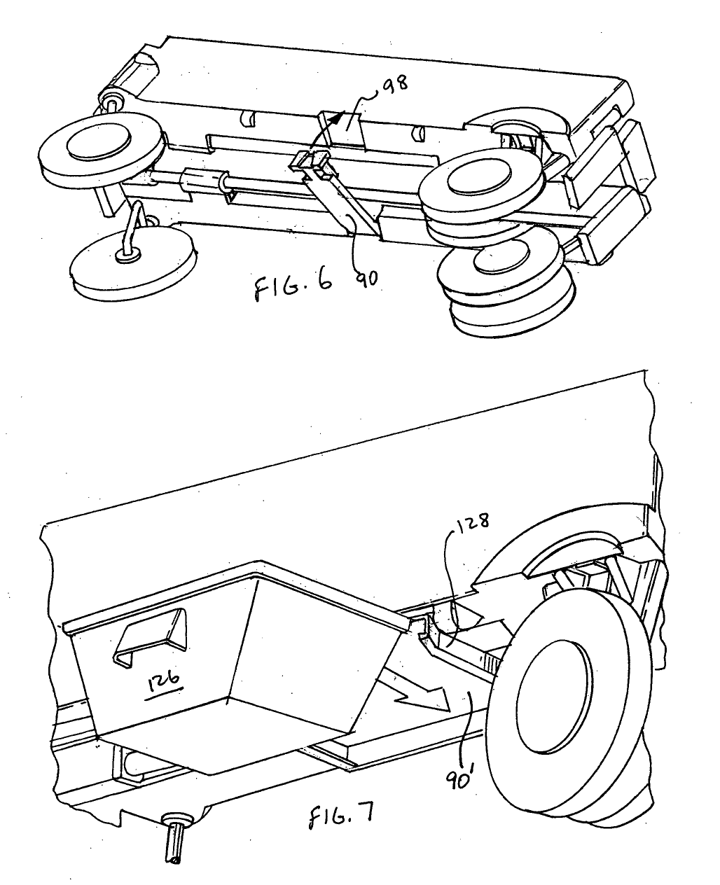

As shown more particularly in FIG. 2, wagon 20 includes locking bar 90 for securing wagon, and more specifically base 30, in a folded position (see FIG. 6) and in an unfolded position (see FIG. 2). As shown in these figures, head 92 of locking bar 90 is placed in unfolded notch 94, which is located on a bottom surface of base 30, for securing wagon 20 in an unfolded position. Locking bar 90 may be pivoted about axis 96 located on a bottom surface of a panel to commence the folding process, which is explained in more detail below. Once the folding process results in the position of wagon 20 shown in FIG. 6, locking bar 90 is placed in folded notch 98, which is located on a bottom surface of an opposite panel.

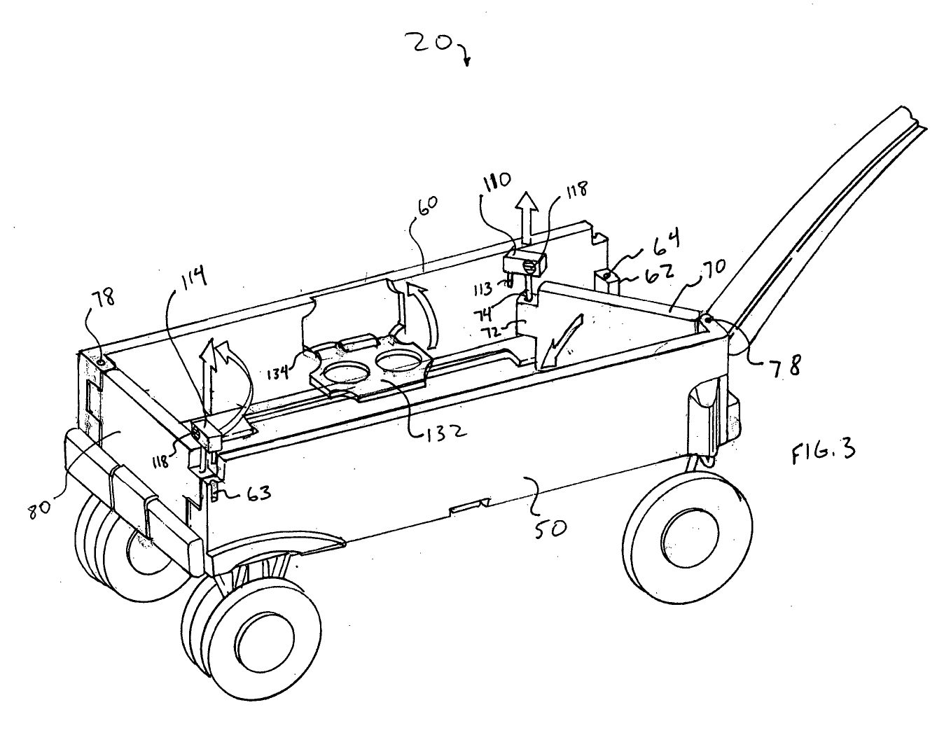

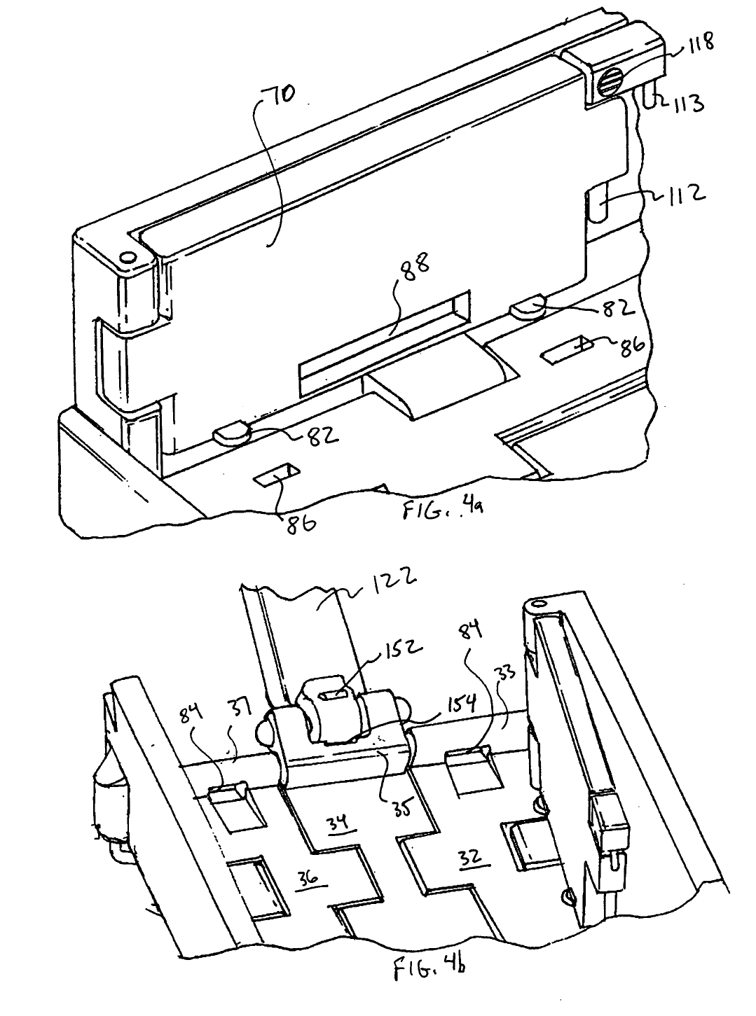

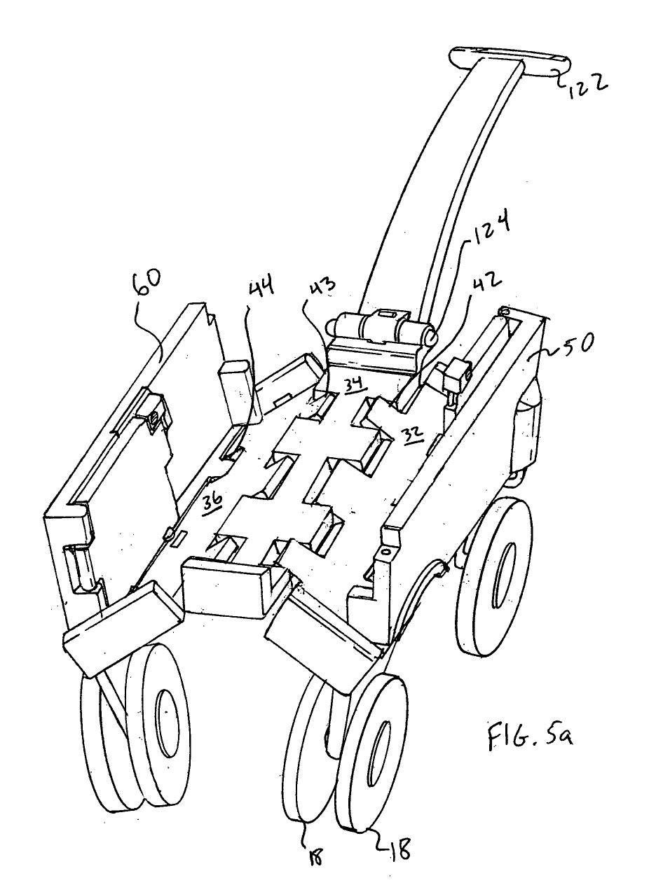

As shown in FIGS. 3 and 4a, front lock 110 is located at a junction between front panel 70 and right side panel 60 for securing front panel 70 to right side panel 60. By securing front panel 70 to right side panel 60, front panel 70 is inhibited from rotating about hinge 78, where front panel 70 being removed from extending across a width of base 30 permits base 30 to commence folding. Hence, front lock 110 is used to secure front panel 70 to right side panel 60 to help maintain base 30 in an unfolded position and, when removed, front panel 70 is free to be folded against left side panel 50. Because front lock 110 is relatively large in comparison with fasteners, such as bolts, nuts, and screws, front lock 110 is less likely to be misplaced or lost. In further embodiments, front lock 110 is attached to wagon 20 via string or chain such that when removed front lock 110 is still attached to wagon 20.

Alternate locking means for front lock 110 or locking bar 90 include a fastener, rivet, screw and nut, nail, hook and loop closing mechanism, tape, adhesive, interference fit, and the like.

Rear lock 114 is located at a junction between back panel 80 and left side panel 50 for securing back panel 80 to left side panel 50. Similar to front lock 110, rear lock 114 inhibits back panel 80 from being rotated about hinge 78. Hence, rear lock 114 is used to secure back panel 80 to left side panel 50 to help maintain base 30 in an unfolded position and, when removed, back panel 80 is free to be folded against right side panel 60. Rear lock 114 and front lock 110 have the same limitations as one another and for the purposes of simplicity, front lock 110 is described in greater detail below but it is understood that such descriptions apply to rear lock 114 as well.

Front lock 110 is shown in FIGS. 3-4b to have rod 112, which passes through hole 74 of extension 72 of front panel 70 and hole 64 of extension 62 of right side panel 60. As shown, extension 72 of front panel is placed above extension 62 of right side panel but other embodiments place extension 62 of right side panel 60 above extension 72 of front panel. All that is needed is for each hole of each extension to substantially align so that rod 112 may be placed through both holes, the result being a front panel 70 being secured to right side panel 60. The alignment between the holes need not be coaxial but need only be substantially close together such that rod 112 may pass through both of them. Optional stopper 113 is placed in notch 63 to inhibit rotation of front lock 110. In further embodiments, front lock 110 has head 111 that is generally round, in which case stopper 113 would be obviated. In a further embodiment, optional grip 118 is placed on either front lock 110, rear lock 114, or both for providing enhanced friction and prevent slippage between a user's hand and front lock 110 and/or rear lock 114.

With the exception of the safety locks, or front and rear locks 110 and 114, foldable wagon 20 folds and unfolds without a fastener. Moreover, wagon 20 folds and unfolds without removing or adding any of the panels.

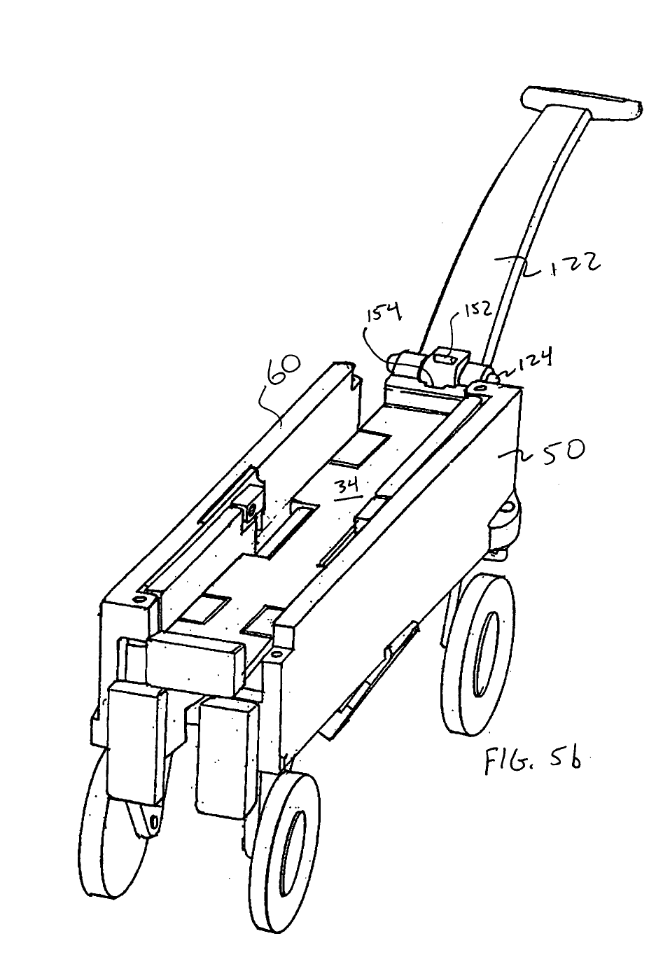

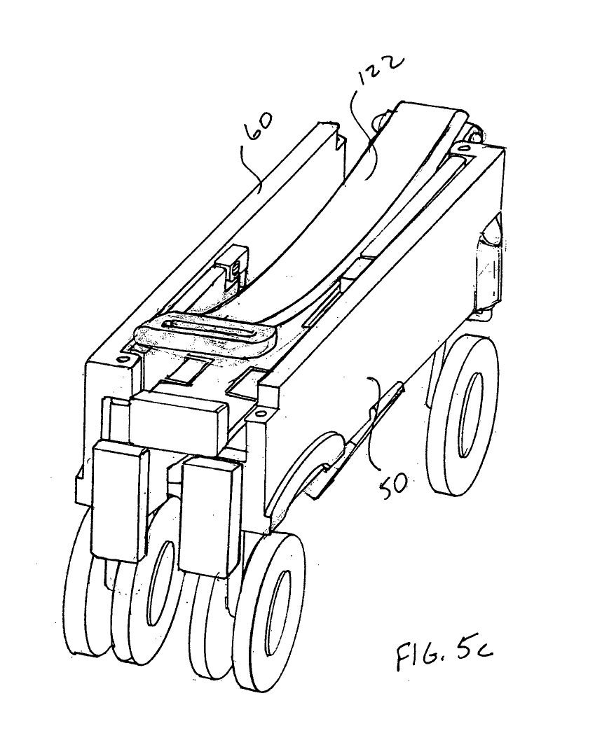

As shown in all the figures, wagon 20 further includes handle 122 pivotably attached to base 30 for maneuvering wagon 20. The design of handle 122 should be sized to fit between left side panel 50 and right side panel 60 when wagon 20 is in the folded position shown in FIG. 5b. Since many designs of handle 122 are possible and may also fit between left side panel 50 and right side panel 60, the embodiment shown should not interpreted to be a limitation of wagon 20.

In some embodiments, nub 152 and orifice 154 are provided for locking handle 122 in a folded position. As shown in FIG. 5b, nub 152 is located on handle 122 and orifice 154 is located on handle base 38. When handle 122 is brought to the position shown in FIG. 5c, nub 152 fits snugly within orifice 154 to lock handle 122 in a folded position.

As shown in all figures, at least one wheel 18 is connected to base 30 for maneuvering wagon 20. Although wheels 18 proximate to front panel 70 are shown to be rotatable about an axis generally perpendicular to base 30 and wheels 18 proximate back panel 80 are rigidly attached to base 30 where no rotation occurs about an axis generally perpendicular to base 30, further embodiments have all wheels 18 be rotatable about an axis generally perpendicular to base 30. In other embodiments, all wheels 18 are rigidly attached to base 30 with no rotation about an axis generally perpendicular to base 30.

In some embodiments, two wheels 18 are used in the front or back of wagon for enhancing structural integrity. In further embodiments, wheel shaft 19 is attached to a side panel (whether right side panel 60 or left side panel 50) or base 30 by bracket 76 and fasteners 77, such as bolts, rivets, nuts, and screws. Bracket 76 is any structure that facilitates securement of wheel shaft 19 to base 30 or a side panel, such as a C shaped plate. As shown in FIGS. 1 and 8, cover 79 is placed over bracket 76 to enhance the aesthetic appearance of wagon 10 by hiding bracket 76 and fasteners 77. By covering fasteners 77, cover 79 reduces the likelihood of fasteners snagging clothing or injuring a user. Cover 79 includes protrusion 83 for snapping into groove 85 of the side panel to secure cover 79 in place.

In reference to FIGS. 2 and 5a-5c, foldable wagon 20 further comprising first hinge 41 placed between left side panel 50 and left length 32; second hinge 42 placed between left length 32 and middle length 34, third hinge 43 placed between middle length 34 and right length 36; and fourth hinge 44 placed between right length 36 and right side panel 60.

To fold wagon 20 from the unfolded state, and referring to FIG. 2, locking bar 90 is rotated about pivot or axis 96, resulting in head 92 of bar 90 being removed from unfolded notch 94. Referring to FIG. 3, front lock 110 and rear lock 114 are removed, which permits a user to fold or rotate front panel 70 and back panel 80 about their respective hinge 78. After rotation, front panel 70 would be folded against left side panel 50 and back panel 80 would be folded against right side panel 60 (see FIGS. 4a, 4b, and 5a).

Without folding or rotating front panel 70 or back panel 80 against their respective side panels, base 30 would not be able to commence folding as shown in FIG. 5a. It should be noted that protrusions 82 in front panel 70 are used to secure front panel 70 to base 30 in the unfolded state by being placed in first recesses 84. First recesses 84 are located on upward walls 33, 37 of left length 32 and right length 36, respectively. See FIGS. 4a-4b. Additionally, middle length 34 has protrusion 35 that is placed within recess 88 of front panel 70 for securing front panel 70 to base 30. When in the folded state (shown in FIG. 6), each protrusion 82 is placed in a respective second recess 86 in base 30. Without second recesses 86, protrusions 82 would get in the way and inhibit the folding process.

In reference to FIGS. 5a and 5b, a user lifts middle length 34 upwardly, which would cause left length 32 to rotate in a clockwise direction shown in FIG. 5a and right length 36 to rotate in a counterclockwise direction shown in FIG. 5a. By rotating, left length 32 rotates about first hinge 41 such that left side panel 50 is brought against left length 32. Left length 32 also rotates about second hinge 42 such that middle length 34 is generally perpendicular to left length 32. Further, right length 36 is rotated about fourth hinge such that right side panel 60 is brought against right length 36. Right length 36 also rotates about third hinge 43 such that middle length 34 is generally perpendicular to right length 36.

It is understood that all pivot points, axes of rotation, or hinges described herein include the same limitations as hinge 78 described above. It should also be understood that back panel 80 has the same limitations as front panel 70, including having protrusions and recesses. Similarly, base 30 has the same limitations in the area of back panel 80 for mating with back panel 80 as base 30 does in the area of front panel 70, as described above, including having similar recesses and protrusions in the area of back panel 80 for mating with the protrusions and recesses of back panel 80. Handle 122 may also be folded by being pivoted around axis 124.

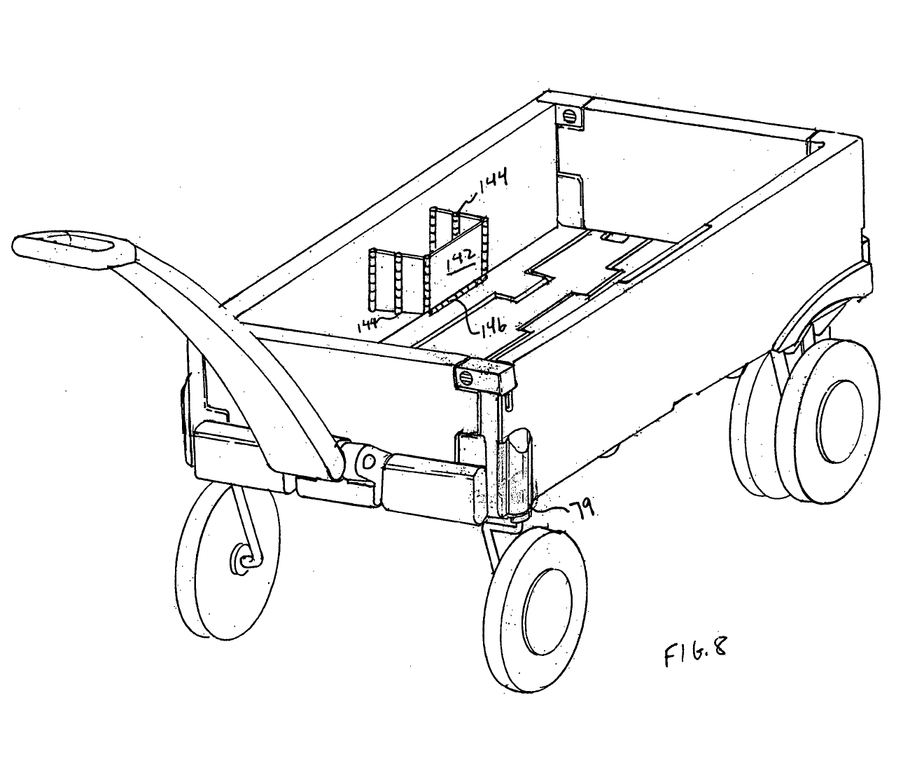

Optionally, and shown in FIG. 7, another embodiment of locking bar 90′ is shown to be a frame to receive container 126 by sliding container 126 along rails 128 of locking bar 90′. Container 126 is used to hold items and the user may access the items in container 126 by sliding it in and out along rails 128.

In another optional embodiment shown in FIG. 3, cup holder 132 is attached to pivot 134 so that cup holder 132 may folded against either left or right side panel 50. 60 when not in use. In addition to or instead of cup holder 132, FIG. 8 depicts toy holder 142 placed against a side panel opposite cup holder 132. Toy holder 142 would be collapsible by being folded about midpoint 144 on both sides of toy holder 142 and where the bottom unsnaps on one side and pivots about axis 146. By being collapsible, toy holder 142 may be stowed away when not in use.

In some embodiments, toy holder 142 is a collapsible box in similar fashion to cardboard packing boxes so that it may be folded against left or right side panel 50, 60. It should be understood that cup holder 132 or toy holder 142 may be attached to back panel 80 or front panel 70 in addition to or instead of either side panel.

What is claimed is:

1. A foldable wagon, comprising:
a base having a left length, a middle length, and a right length, said left and right lengths being hingedly connected to said middle length such that said left and right lengths may be pivoted downwardly relative to said middle section;
a left side panel hingedly attached to said left length of said base;
a right side panel hingedly attached to said right length of said base
a front panel hingedly attached to one of said left side panel and said right side panel;
a back panel hingedly attached to the other of said left side panel and right side panel;
a handle hingedly attached to said middle length, said handle having a width;
one or more wheels mounted to each of said left side panel and said right side panel;
said foldable wagon being positionable in an unfolded state with said left length, middle length, and right length of said base aligned to form a generally planar surface, and said left and right side panels extending generally upwardly from said base, and said front and rear panels positioned between said left side and right side panels and extending generally upwardly from said base;
means for locking said front panel in location between said left and right panels when said base is in an unfolded state;
means for locking said back panel in location between said left and right panels when said base is in an unfolded state;
said foldable wagon being positionable in a folded state with said left length and right length of said base pivoted downwardly from said middle length, and said front and rear panels extending generally parallel to said left side and right side panels, and said left side and right side panels pivoted to extend generally upwardly from said base;
a locking bar hingedly attached to one of said left side panel and said right side panel having means for engaging with the other of said left side panel and said right side panel for securing said wagon in a folded state, said locking bar being engageable with said middle length of said base for securing said wagon in an unfolded state.

2. The foldable wagon according to claim 1, wherein said front panel further includes a protrusion and said base includes a recess, wherein said protrusion is placed within said recess for securing said front panel to said base.

3. The foldable wagon according to claim 2, wherein said base has a first recess for securing said front panel to said base in an unfolded position and said base has a second recess for securing said front panel to said base in a folded position.

4. The foldable wagon according to claim 1, wherein said handle width is less than a distance between said left side panel and said right side panel when said wagon is in a folded state and wherein said handle can be pivoted to a location between said left side panel and said right side panel.

5. The foldable wagon according to claim 1, wherein said wheels comprise a pivoting front wheel mounted on each of said left side panel and right side panel, and a fixed rear wheel mounted on each of said left side panel and right side panel.

6. A foldable wagon, comprising:
a base;
a left side panel, a right side panel, a front panel, and a back panel all placed on said base and all approximately perpendicular to said base;
said front panel is hingedly attached to said left side panel;
said back panel is hingedly attached to said right side panel;
a safety lock located at a junction between two adjacent panels for securing the adjacent panels together; and
a locking bar attached to said base to secure the wagon in a folded or unfolded position;
wherein the foldable wagon folds and unfolds without a fastener; and
wherein the foldable wagon folds and unfolds without removing or adding any of said panels.

7. The foldable wagon according to claim 6, wherein said safety lock is a front lock located at a junction between said front panel and said right side panel for securing said front panel to said right side panel, wherein said safety lock helps maintain said base in an unfolded position and, when removed, said front panel is free to be folded against said right side panel.

8. The foldable wagon according to claim 6, wherein said safety lock is a rear lock located at a junction between said rear panel and said left side panel for securing said rear panel to said left side panel, wherein said safety lock helps maintain said base in an unfolded position and, when removed, said front panel is free to be folded against said right side panel.

9. The foldable wagon according to claim 6, wherein said front panel and said right side panel each have an extension with a hole, where both holes align with one another in an axial direction, and wherein said front lock is a rod that extends through both holes.

10. The foldable wagon according to claim 6, said base having a left length, a middle length, and a right length.

11. he foldable wagon according to claim 10, further comprising a first hinge placed between said left side panel and said left length; a second hinge placed between said left length and said middle length; a third hinge placed between said middle length and said right length; and a fourth hinge placed between said right length and said right side panel.

12. The foldable wagon according to claim 6, further comprising a wheel attached to said base.

13. The foldable wagon according to claim 6, wherein said locking bar is pivotably attachable to said base in a first location for securing said base in a folded position and in a second location for securing said base in an unfolded position.

14. A foldable wagon, comprising:
a base having a left length, a middle length, and a right length;
a left side panel, a right side panel, a front panel, and a back panel all placed on said base and all approximately perpendicular to said base;
said front panel is hingedly attached to said left side panel;
said back panel is hingedly attached to said right side panel;
a front lock located at a junction between said front panel and said right side panel for securing said front panel to said right side panel, wherein said front lock helps maintain said base in an unfolded position and, when removed, said front panel is free to be folded against said right side panel and said base is free to be folded between adjacent lengths;
a rear lock located at a junction between said rear panel and said left side panel for securing said rear panel to said left side panel, wherein said rear lock helps maintain said base in an unfolded position and, when removed, said front panel is free to be folded against said right side panel and said base is free to be folded between adjacent lengths; and
a locking bar attached to said base for securing said base in a folded or unfolded position;
wherein said base and said panels fold without a fastener and without removing or adding any of said panels or lengths.

15. The foldable wagon according to claim 14, wherein said front panel further includes a protrusion and said base includes a recess, wherein said protrusion is placed within said recess for securing said front panel to said base.

16. The foldable wagon according to claim 15, wherein said base has a first recess for securing said front panel to said base in an unfolded position and said base has a second recess for securing said front panel to said base in a folded position.

17. The foldable wagon according to claim 14, wherein said front panel further includes a recess and said base includes a protrusion, wherein said protrusion is placed within said recess for securing said front panel to said base.

18. The foldable wagon according to claim 14, further comprising a container attached to said locking bar.

19. The foldable wagon according to claim 14, further comprising a cup holder pivotably attached to said left side panel or said right side panel.

20. The foldable wagon according to claim 14, further comprising a toy holder pivotably attached to said back panel or said front panel.
